(19) United States
(12) Patent Application Publication
(10) Pub. No.: US 2006/0225524 A1
(43) Pub. Date: Oct. 12, 2006

(54) Reconstruction of an angle signal from the signal of a sensor for angles of rotation

(76) Inventors: Hilko Hakvoort, Berlin (DE); Arie-Govert Aanen, Stuttgart (DE)

Correspondence Address: KENYON & KENYON LLP, ONE BROADWAY, NEW YORK, NY, 10004, US

(21) Appl. No.: 10/537,033

(22) PCT Filed: Jul. 8, 2003
(86) PCT No.: PCT/DE03/02261

§ 371 Date: Nov. 14, 2005

(30) Foreign Application Priority Data
Nov. 28, 2002 (DE) 102 55 468.4

(51) Int. Cl. G01B 21/22

(52) U.S. Cl. 73/866.1; 702/151

(57) ABSTRACT

A method is described for construction of an angle signal from the sensor signal of a rotation angle sensor which has a periodic characteristic curve featuring a plurality of segments between which characteristic curve jumps occur. To reconstruct the angle signal, positive and negative signal jumps of the sensor signal are determined, and when a positive or negative signal jump is determined, a segment number is generated. An analyzer unit reconstructs the angle signal on the basis of the segment number and the sensor signal.

### FIELD OF THE INVENTION

The present invention relates to a method for reconstruction of an angle signal from the sensor signal of a rotation angle sensor and to a rotation angle sensor system.

### BACKGROUND INFORMATION

Rotation angle sensors are used in a plurality of applications for measuring angular positions of rotating objects. Magnetic or optical sensors which permit contactless measurements are typically used. One application in the automotive industry is, for example, the determination of the steering wheel angle or steering angle of a motor vehicle.

FIG. 1 shows a measuring device known from the related art for measuring the rotation angle of a rotating shaft 1 which is rotatable in the direction of arrow A. The measuring device depicted here has a sensor 2 situated on one end of shaft 1, which has an analyzer unit 4 connected to it, sensor 2 cooperating with a stationary transducer 3. Transducer 3 includes in this case a permanent magnet which induces a voltage in sensor 2, for example. Hall sensors, -magnetoresistive sensors (MR sensors), magnetotransistors, etc. may be used as a sensor element.

A typical rotation angle sensor such as often used for detecting the steering wheel angle in a motor vehicle has, for example, the characteristic curve shown in FIG. 2a. As the figure shows, the sensor signal α_{S} of sensor 2 includes the entire measuring range (e.g., steering wheel angle α_{L} between −800° and +800°), so that the actual steering wheel angle α_{L} is output at the output of sensor 2, i.e., analyzer unit 4. A steering movement as represented in FIG. 2b by reference numeral 6, in which the steering wheel is rotated from zero position (α_{L}=0°) to the right-hand stop (e.g., α_{L}=800°) and from there back to zero position is therefore unambiguously displayed by sensor 2. Sensor signal 7 is therefore depicted in FIG. 2b as a stepped signal because in this example it is a digitized signal 7.

Sensor signal 7 may be further processed by additional systems 4 present in the vehicle such as, for example, a vehicle dynamics control system (e.g., electronic stability program ESP).

Sensors 2 having a linear characteristic curve over a large measuring range have the disadvantage that they have a relatively complex design and are therefore expensive.

It is therefore desirable to use other standard sensors of a simpler design for angle measurements which, in particular, need no means for counting full revolutions or recognizing the direction of rotation. Such a sensor may be implemented, for example, by a plurality of MR sensors.

The characteristic curve of such a rotation angle sensor is shown in FIG. 3a as an example. As the figure shows, the measuring range of the rotation angle sensor only includes a partial range (from −p to +p) of a total measuring range for a rotation angle α_{L}. For angles α_{L} outside of the partial measuring range (e.g., between −120° and +120°), characteristic curve 5 of the sensor is periodically repeated. Characteristic curve 5 has a jump 8 between the individual periods of characteristic curve 5, which may also be called segments S. For example, if the partial measuring range of the rotation angle sensor includes angles between −120° and +120°, rotation angles α_{L} situated in this range are unambiguously displayed. In contrast, for a rotation angle of 121°, the rotation angle sensor delivers an output signal αₛ, identical to that delivered for a rotation angle of −119°.

A rotational movement of a shaft as represented in FIG. 3b by reference numeral 6 will thus result in sensor signal 7. It is not possible to directly process such a sensor signal 7 using a downstream device 4 such as, for example, an ESP system, because sensor signal 7 is not unambiguous.

### SUMMARY OF THE INVENTION

An object of the present invention is therefore to reconstruct, from a sensor signal of a rotation angle sensor having a periodic characteristic curve featuring a plurality of segments, an angle signal which unambiguously renders the actual rotation angle of an object since the initialization of the sensor.

The present invention monitors the sensor signal of the rotation angle sensor and determines positive or negative signal jumps in the sensor signal. In determining the signal jump, a segment value is generated, which specifies in which segment of the sensor characteristic curve the currently measured rotation angle is situated since the initialization of the sensor. An analyzer unit may thus determine the actual total rotation angle (since the initialization of the sensor) in a simple fashion and reconstruct an unambiguous angle signal. A particularly simple and therefore cost-effective rotation angle sensor may thus be used.

According to a preferred embodiment of the present invention, the positive and negative signal jumps in the sensor signal are determined via threshold value monitoring of the rate of change of the sensor signal. This means that a signal jump is assumed when the rate of change of the sensor signal exceeds a predefined threshold value. By comparing the angle values delivered by the rotation angle sensor, it may be determined in a simple fashion whether the jump is positive (from smaller values to larger values) or negative (from larger values to smaller values).

A segment counter is preferably provided, which contains a predefined segment value SN (for example, SN=0) and which is incremented or decremented in the event of a positive or negative jump. For a sensor characteristic curve such as shown in FIG. 3a, the segment counter is preferably incremented by one in the event of a negative signal jump and decremented by one in the event of a positive signal jump.

The analyzer unit may reconstruct the actual angle signal from the instantaneous sensor signal in conjunction with the corresponding segment value in a simple manner. To do so, the processing unit preferably adds an angle, which is a function of the segment value, to the sensor signal. For example, an angle SN*α(S) is added to the sensor signal, SN being the segment value and α(S) an angle corresponding to the segment size.

A rotation angle sensor system according to the present invention includes a rotation angle sensor which has a periodic characteristic curve featuring a plurality of segments between which characteristic curve jumps occur, and a processing unit which is capable of reconstructing an angle signal, which unambiguously reproduces the actual rotational movement of a device since the initialization of the rotation angle sensor, from the sensor signal and a segment value, the processing unit operating as described previously.

### BRIEF DESCRIPTION OF THE DRAWINGS

FIG. 1 shows an example of a measuring device for measuring a rotation angle of a rotating shaft.

FIG. 2a shows the characteristic curve of a rotation angle sensor known from the related art.

FIG. 2b shows the sensor signal of the rotation angle sensor of FIG. 2a.

FIG. 3a shows the sensor characteristic curve of a known rotation angle sensor having a periodic characteristic curve.

FIG. 3b shows the sensor output signal of the sensor of FIG. 3a.

FIG. 4a shows a sensor signal of a rotation angle sensor having a periodic characteristic curve FIG. 4b shows the counter content of a segment counter when the signal of FIG. 4a is applied FIG. 4c shows the reconstructed angle signal.

FIG. 5 shows a flow chart showing the essential method steps in reconstructing an angle signal from a sensor signal.

### DETAILED DESCRIPTION

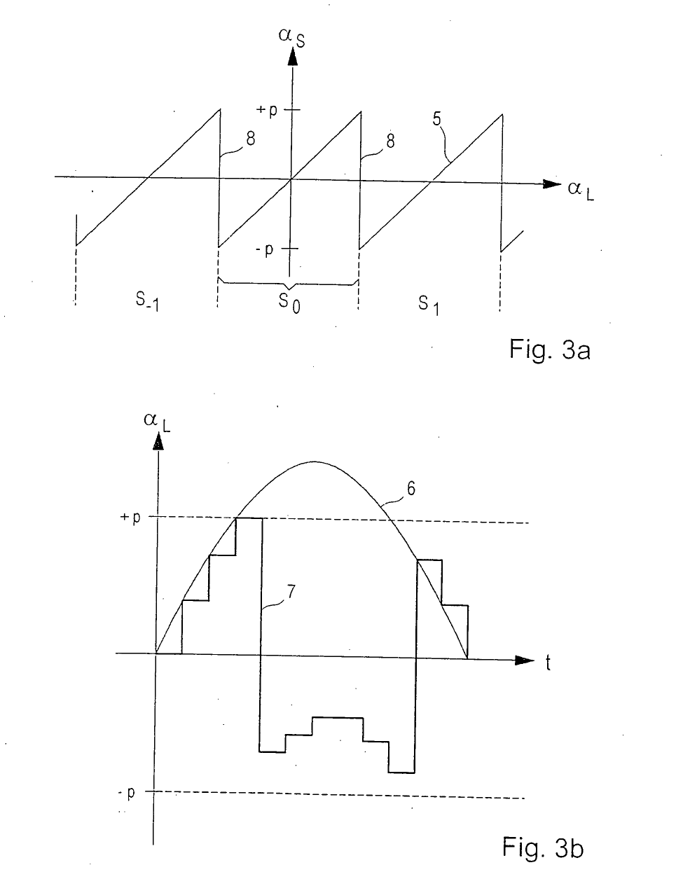

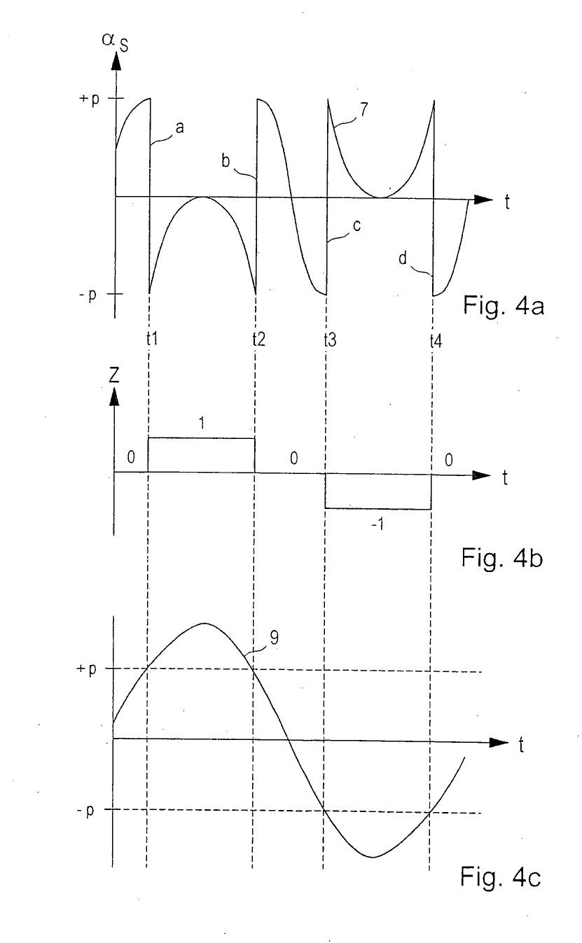

FIG. 4a shows a sensor signal 7 of a rotation angle sensor 2 having a periodic characteristic curve as shown in FIG. 3a as an example. Signal jumps a-d in sensor signal 7 result from the actual rotation angle α_{L} of shaft 1 going beyond the partial measuring boundaries −p, +p of rotation angle sensor 2. This is elucidated in detail on the basis of an illustrative example.

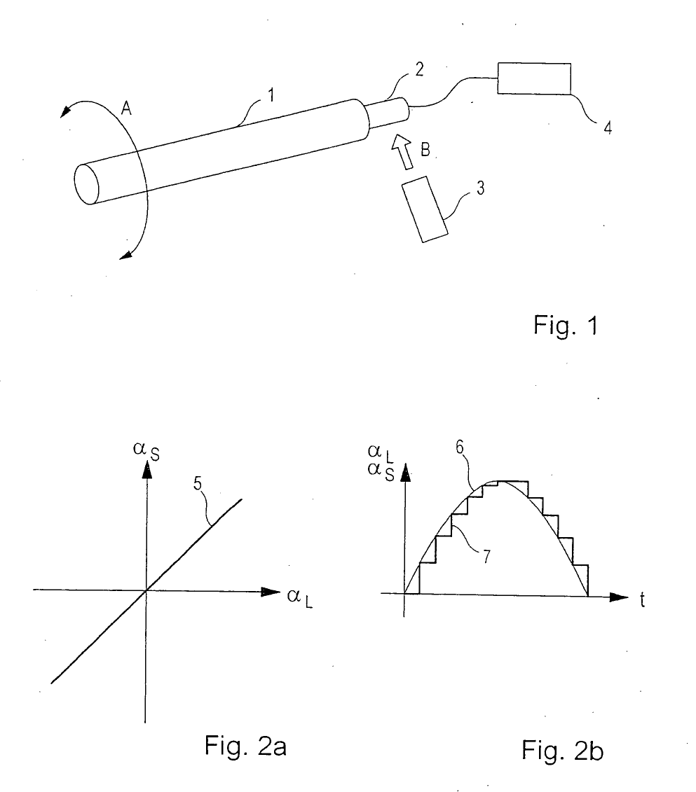

A system such as that represented in FIG. 1 is used, for example, for determining the steering wheel angle of a motor vehicle. Rotation angle sensor 2 is capable, for example, of measuring rotation angles in a partial measuring range of −180° (−p) to +180° (+p). This partial measuring range corresponds to segment S0 of the sensor characteristic curve of FIG. 3a. Rotation angles outside this segment S0 are displayed in the same measuring range; therefore it is impossible to specify the position in an unambiguous manner, i.e., an angle of +185° will generate the same sensor output value as a rotation angle of −175°.

If the rotational movement of shaft 1 goes beyond segment boundary +p at time t1, the sensor output signal makes a return-jump a to the sensor output value of the next segment S1. The actual rotation angle α_{L} of shaft 1 is in the time segment t1 to t2, i.e., in segment 1 of the sensor characteristic curve of FIG. 3a.

At time t2, rotation angle α_{L} drops again below the segment boundary between segments S0 and S1. The sensor signal thus jumps at time t2 (FIG. 4a) to the end value of segment S0. This positive signal jump is identified using reference symbol b. Therefore, between times t2 and t3 the actual rotation angle is situated in segment S0.

When the shaft rotates further backward, the rotation angle drops below lower segment boundary −p of segment S0 and sensor signal 1 jumps with a positive signal jump c (see characteristic curve of FIG. 3a) to the end value of segment S-₁. Actual rotation angle α_{L} is therefore situated in segment S-₁.

If the direction of rotation of the shaft is reversed between times t3 and t4, and at time t4 the actual rotation angle exceeds the segment boundary between segment S-₁ and segment S0, a negative signal jump d occurs in sensor signal 7.

The segment containing the actual rotation angle (since the initialization of sensor 2) is represented using a segment value SN as shown in FIG. 4b. The rotation angle sensor system of FIG. 1 includes, for this purpose, a segment value counter which has a predefined value (preferably 0) when the rotation angle sensor is initialized and which is either incremented or decremented depending on whether a positive or a negative signal jump occurs in the sensor signal of FIG. 4a.

A signal jump is recognized by signal processing unit 4 in that the rate of change of the sensor signal exceeds a predefined threshold value. Processing unit 4 may now reconstruct angle signal 9 shown in FIG. 4c in a simple fashion. For this purpose, it adds SN times a segment width, for example, SN*360°, where SN is the segment value, to instantaneous sensor signal 7.

In the previous example it was assumed that shaft 1 is in the zero position when rotation angle sensor 2 is initialized, i.e., in segment S0. In contrast, if shaft 1 is in an angle position outside of segment S0, angle signal 2 must still be corrected by this difference. The offset present at the time of initialization of rotation angle sensor 2 may be taken into account, for example, by storing the shaft position when sensor 2 is turned off (assuming that shaft 1 is not moved while the sensor is turned off).

In the case of a steering wheel angle sensor in a motor vehicle, sensor 2 is initialized, for example, when the ignition is turned on, and sensor 2 is turned off when the ignition is turned off. Since the steering wheel is usually blocked in the parking position when the ignition is turned off, the angular position of the steering wheel when the ignition is turned on corresponds to the previous position of the steering wheel when the ignition was turned off.

Further measures for recognizing an offset of rotation angle sensor 2, such as the use of an additional sensor, for example, are also conceivable.

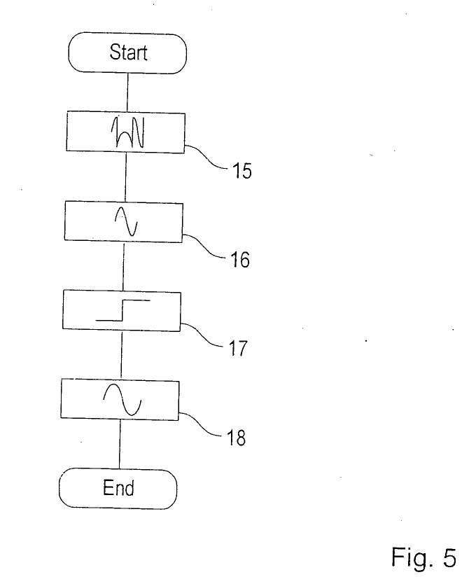

FIG. 5 shows the essential method steps of a method for reconstruction of an angle signal 9 from sensor signal 7 of a rotation angle sensor 2 which has a periodic characteristic curve 3 featuring a plurality of segments S between which characteristic curve jumps 8 occur.

In a first step 15, sensor signal 7 is input, and in step 16 positive and negative signal jumps a-d of sensor signal 7 are detected. When determining a signal jump in step 17, a segment value SN is generated, which specifies in which segment S of sensor characteristic curve 3 the currently measured rotation angle α_{L} is situated. In step 18 analyzer unit 4 is able to determine the total rotation angle since the initialization of sensor 2 from sensor signal 7 and segment value SN. For this purpose, analyzer unit 4 adds an angle to sensor signal 7, for example, which is a function of segment value SN and the segment width.

### REFERENCE SYMBOL LIST

1 shaft
2 sensor
3 transducer
4 analyzer unit
5 sensor characteristic curve
6 movement
7 sensor output signal
8 characteristic curve jumps
9 reconstructed angle signal
15-18 method steps
S segment
SN segment number
α_{L} rotation angle
αₛ rotation angle displayed by the sensor
+p, −p segment boundaries
t1-t4 times
a-d signal jumps

1.-10. (canceled)

11. A method for reconstruction of an angle signal from a sensor signal of a rotation angle sensor having a periodic characteristic curve featuring a plurality of segments between which characteristic curve jumps occur, comprising:
determining positive and negative signal jumps in the sensor signal;
generating a segment value after a signal jump has been determined, wherein the segment value specifies in which segment a currently measured rotation angle is located; and
reconstructing the angle signal from the sensor signal and the segment value.

12. The method as recited in claim 11, wherein the positive and negative signal jumps are determined by threshold monitoring of a rate of change of the sensor signal.

13. The method as recited in claim 11, further comprising:
one of incrementing and decrementing the segment value when one of a positive signal jump and a negative signal jump is detected.

14. The method as recited in claim 11, further comprising:
adding to the sensor signal an angle that is a function of the segment value and a segment width.

15. The method as recited in claim 11, further comprising:
correcting an offset of the reconstructed angle signal.

16. A rotation angle sensor system, comprising:
a rotation angle sensor having a measuring range including only one partial range of a total measuring range, the rotation angle sensor having a periodic characteristic curve featuring a plurality of segments between which characteristic curve jumps occur; and
an analyzer unit, wherein:
the analyzer unit detects positive and negative signal jumps in a sensor signal,
the analyzer unit determines a new segment value after an occurrence of one of a positive signal jump and a negative signal jump, and
the analyzer unit reconstructs an unambiguous angle signal from the sensor signal and the segment value.

17. The rotation angle sensor system as recited in claim 16, wherein the analyzer unit monitors a sensor signal threshold value to detect positive and negative signal jumps.

18. The rotation angle sensor system as recited in claim 16, wherein the analyzer unit includes a segment counter that is one of incremented and decremented when one of the positive signal jump and the negative signal jump is detected.

19. The rotation angle sensor system as recited in claim 16, wherein the analyzer unit adds to the sensor signal an angle that is a function of the segment value and a segment width.

20. The rotation angle sensor system as recited in claim 16, further comprising:
an arrangement for detecting an offset when the rotation angle sensor system is initialized.
